(19) United States
(12) Patent Application Publication
(10) Pub. No.: US 2015/0145622 A1
(43) Pub. Date: May 28, 2015

(54) ROTARY MAGNET SWITCH

(71) Applicant: QinetiQ North America, Inc., Reston, VA (US)

(72) Inventors: Edward J. Terrenzi, Fairhaven, MA (US); Faheem F. Faheem, Sudbury, MA (US); Donald MacLeod, Millbury, MA (US); Ross Malin, Easton, MA (US); M. Spenser Brouwer, Franklin, MA (US); Paul William Paolillo, Providence, RI (US); Scott Quigley, Franklin, MA (US)

(73) Assignee: QinetiQ North America, Inc., Reston, VA (US)

(21) Appl. No.: 14/088,660

(22) Filed: Nov. 25, 2013

(51) Int. Cl. H01H 50/24

(52) U.S. Cl. CPC H01H 50/24
USPC 335/125

(57) ABSTRACT

A rotary magnet switch includes a housing defining a cavity for a rotary magnet having a first section rotatable with respect to a second section. A first registration secures the first magnet section to the housing. An actuator extends from a side wall of the housing. The actuator is secured to the second magnet section and is configured to rotate the second magnetic section with respect to the housing and the first magnet section to switch the magnet on and off.

### FIELD OF THE INVENTION

The invention relates to switches for magnet assemblies, for example, a switch for a rotary switchable multi-core element permanent magnet-based apparatus.

### BACKGROUND OF THE INVENTION

U.S. Pat. Nos. 7,012,495 and 8,350,663, both incorporated herein by this reference, disclose rotary switchable magnets. The design of the switchable magnet of U.S. Pat. No. 8,350,663 results in a stronger holding force, for example 400 lbs, in a small package.

### SUMMARY OF THE INVENTION

In order for such switchable magnets to be used, for example, in military applications, a switch housing for the magnet must be developed which also has a small footprint, which is easy to manufacture and use, and which is highly reliable for quick engagement and detachment of systems to a ferromagnetic body.

In order to reliably secure one component to another component using the rotary magnet and switch, it is preferable that the switch actuator does not interfere with the top or bottom of the switch housing since the top of the housing usually includes a fastener (securing the housing to one component) and the bottom of the housing includes an exposed portion of the rotary magnet (securing the housing to another component).

Featured is a rotary magnet switch comprising a housing defining a cavity for a rotary magnet having a first section rotatable with respect to a second section. A first registration secures the housing and the first magnet section together. An actuator extends from the housing. A second registration secures the actuator and the second magnet section and is configured to rotate the second magnetic section with respect to the housing and the first magnet section. In some examples, the actuator is slideable with respect to the housing and includes an off axis ear with an orifice therein receiving a pin extending off axis from a bottom surface of the second magnet section. The housing may include a linear track for the actuator. In another design, the actuator includes a slot receiving a pin attached to the housing constraining the actuator to slide linearly. The first registration may include pins extending from a side wall of the first magnet section received in a side wall of the cavity.

The switch housing may include two sections coupled together. The housing cavity preferably has a configuration (e.g., depth) exposing a top surface of the first magnet section. In one design, the top surface of the first magnet section is flush with the housing. In another design, the top surface of the first magnet section extends beyond the housing.

The housing may further include a fastener component such as an ear. The switch may include two housings connected via a member. In one example, the actuator extends into both housings via the member. The switch housing can be made of a polymer. Preferably, the actuator extends from a side wall of the housing.

Also featured is a rotary magnet switch comprising a housing in two portions defining a cavity for a rotary magnet having a first section residing in and locked to the housing first portion as exposed at one housing surface. The second housing portion receives the rotary magnet second section which is rotatably disposed therein. An actuator through a side wall of the second housing portion, extends into the cavity, and is registered with the rotary magnet second section.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three dimensional top view of an example of a rotary magnet switch in accordance with the invention;

FIG. 2 is a schematic three dimensional view showing the bottom of the switch of FIG. 1;

FIG. 3 is a schematic three dimensional partially exploded cross sectional view showing an example of a rotary switch in accordance with the invention releasably securing one component to another component;

FIG. 4 is a schematic three dimensional top view of an example of a rotary magnet in accordance with examples of the invention;

FIG. 5 is a schematic three dimensional bottom view of an example of a switch;

FIG. 6 is a schematic three dimensional view of an example of a switch actuator;

FIG. 7 is a schematic top view of the switch actuator of FIG. 6;

FIG. 8 is a schematic three dimensional view showing another example of a switch actuator;

FIG. 9 is a schematic top view showing two switches coupled by a bar member;

FIG. 10 is a schematic three dimensional top view showing one switch of the assembly of FIG. 9;

FIG. 11 is a schematic three dimensional view showing a plurality of switches in accordance with examples of the invention used in connection with the frame members of a hard point net; and

FIG. 12 is a schematic three dimensional view showing a plurality of switches in accordance with examples of the invention secured to an armor panel.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

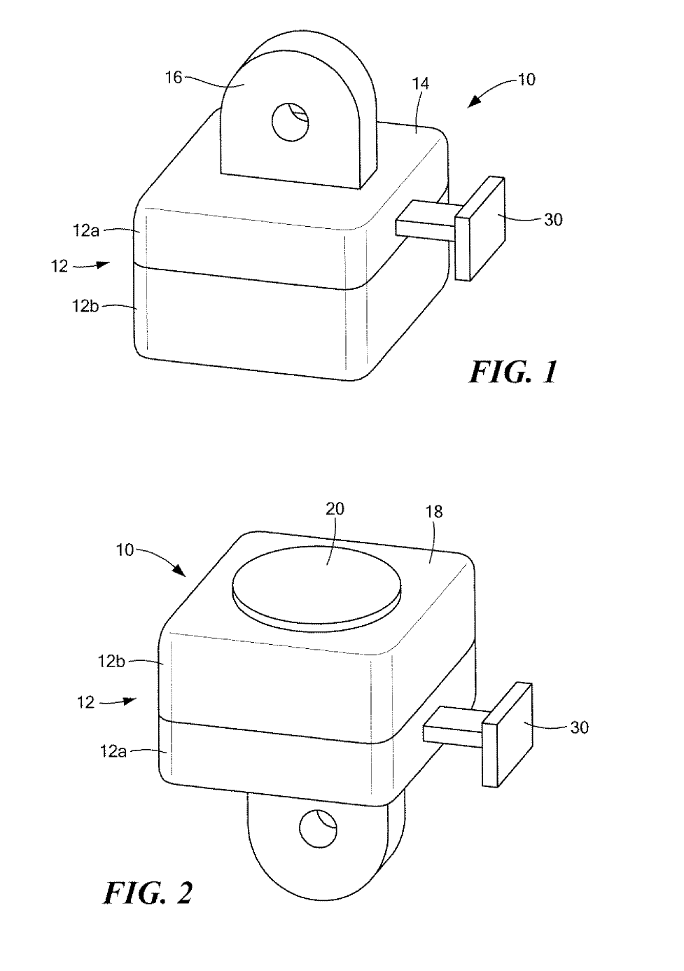

FIGS. 1-2 show an example of a rotary magnet switch 10 with housing 12 in two portions or sections 12a and 12b. The top surface 14 of housing section 12a here includes a fastener component such as ear 16 for a strut (not shown). The bottom surface of 18 of housing section 12b includes exposed top surface 20 of first magnet section 22a, FIG. 4. The second magnet section 22b resides in housing portion 12a and is rotatable therein via actuator 30, FIG. 1-2, registered to second magnet section 22b to switch the magnet on and off. Here, actuator 30 extends from a side wall of housing section 12a. In some designs, the top surface 20 of the first magnet section is flush with the bottom surface of the housing. In other designs, top surface 20 extends slightly outward from the bottom surface of the housing.

In one example, pushing on actuator 30 rotates second magnet section 22b 40° with respect to first magnet section 22a switching the magnet on (e.g., aligning the pole conduits in-phase). Pulling on actuator 30 switches the magnet off (e.g., aligning the pole conduit out-of-phase). See U.S. Pat. No. 8,350,663.

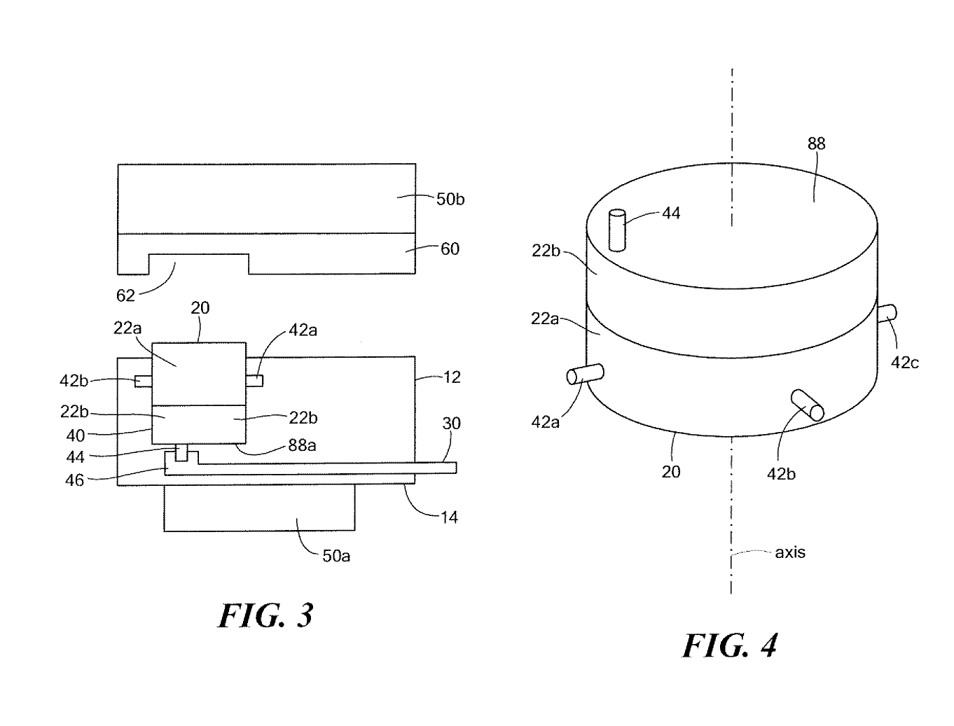

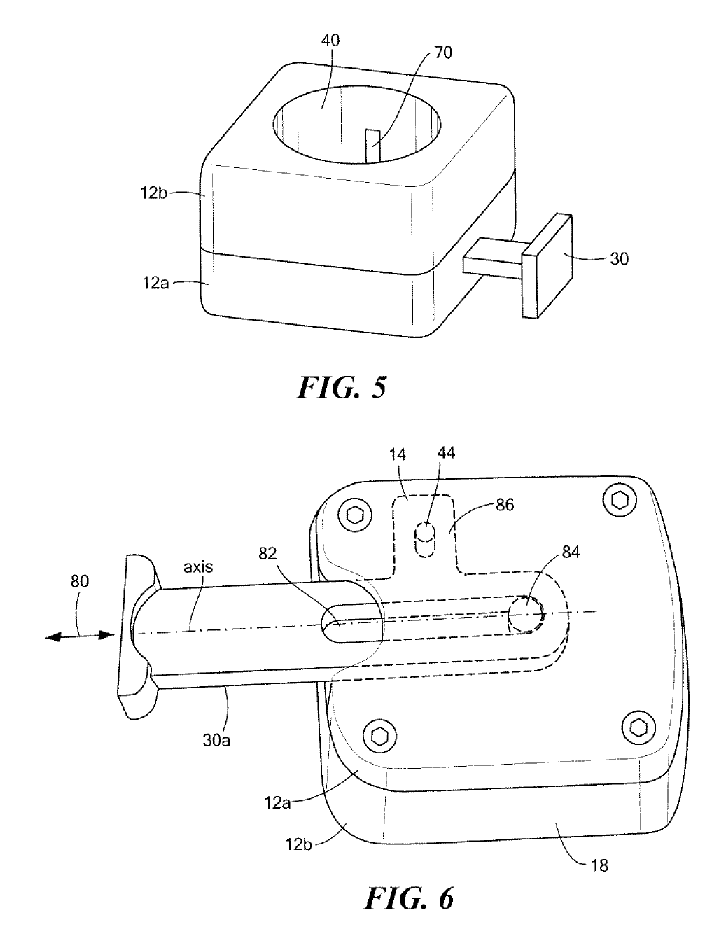

More generally, FIG. 3 shows housing 12 with cavity 40 (see also FIG. 5) for magnet sections 22a and 22b. Fist magnet section 22a is registered (e.g., fixed) to the housing using, for example pins 42a, 42b and the like extending from the side of section 22a received in corresponding sockets in housing 12. Actuator 30 extends from housing 12 and is registered to second magnet section 22b via pin 44 received in ear 46 of actuator 30.

Housing 12 top surface 14 may include a fastener component such as ear 16, FIGS. 1-2 or an eyebolt, velcro, an adhesive, or a tapped hole or holes to receive a threaded fastener or fasteners and thus can be coupled to a first structure 50a. Magnet surface 20 is attracted to second structure 50b which may include, if necessary, ferromagnetic receiver component 60 adhered or fastened to structure 50b and including, in some example, recess 62 for exposed magnet portion 20.

In this way, for example, armor can be secured to switch housing surface 14 and then releasably secured to vehicle hull 50b via the switchable magnet. If vehicle hull 50b is ferrous, receiver 60 may not be needed. In another example, a strut of a hard point net or other structure serves as structure 50a and structure 50b is a military vehicle. Other examples include releasably attaching armored window frames, sensors, racks, and the like to a vehicle or structure.

FIG. 5 shows housing 12 cavity 40 with housing section 12b including slots such as slot 70 for a side wall pin 42, FIG. 3 of fixed magnet section 22a. Housing portions 12a and 12b can be coupled together using fasteners in order to assemble the magnet sections therein. In other designs, magnet section 22a is fixed to the housing using other means such as a press fit, adhesives, fasteners, and the like.

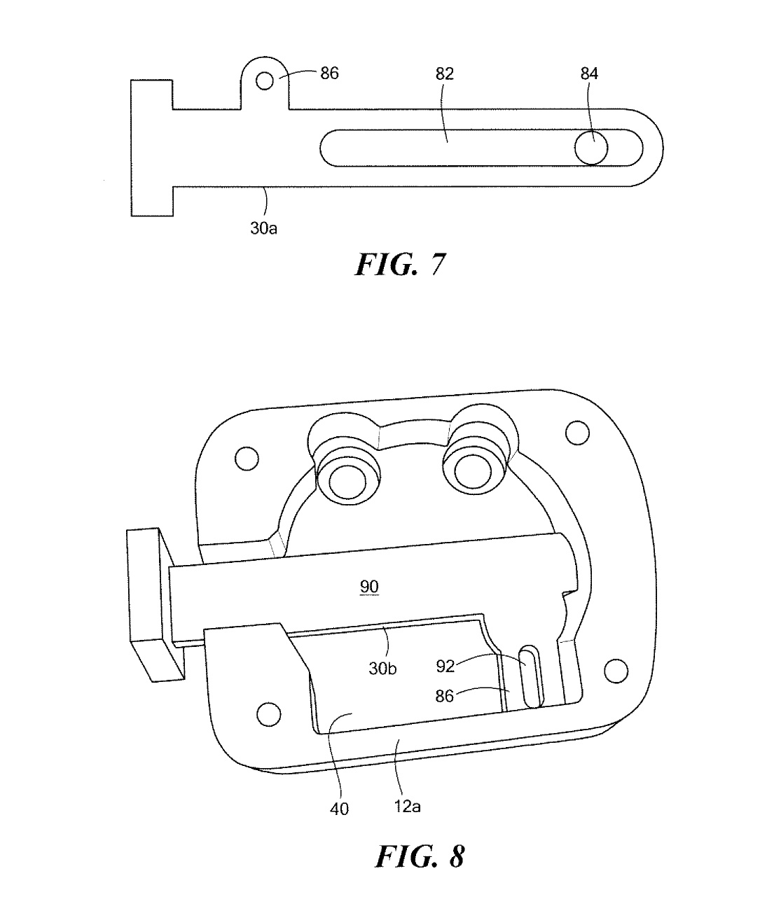

FIGS. 6-7 show actuator 30a slideable with respect to the housing and extending from the side wall of housing section 12a. Actuator 30a is constrained to slide linearly in the direction shown by arrow 80 in and out via slot 82 receiving housing pin 84 therein. Off axis ear 86 includes an orifice receiving pin 44 extending off axis from the bottom surface 88 of magnet section 22b. In this way, one magnet section is rotated relative to the other via pushing and pulling on actuator 30a.

FIG. 8 shows a design where actuator 30b is constrained to slide linearly with respect to housing section 12a via a track 90 in the bottom wall of cavity 40. Offset ear 86 has orifice 92 for receiving pin 44, FIGS. 3-4, Again, by pushing and pulling on actuator 30b, one magnet section is rotated with respect to the other.

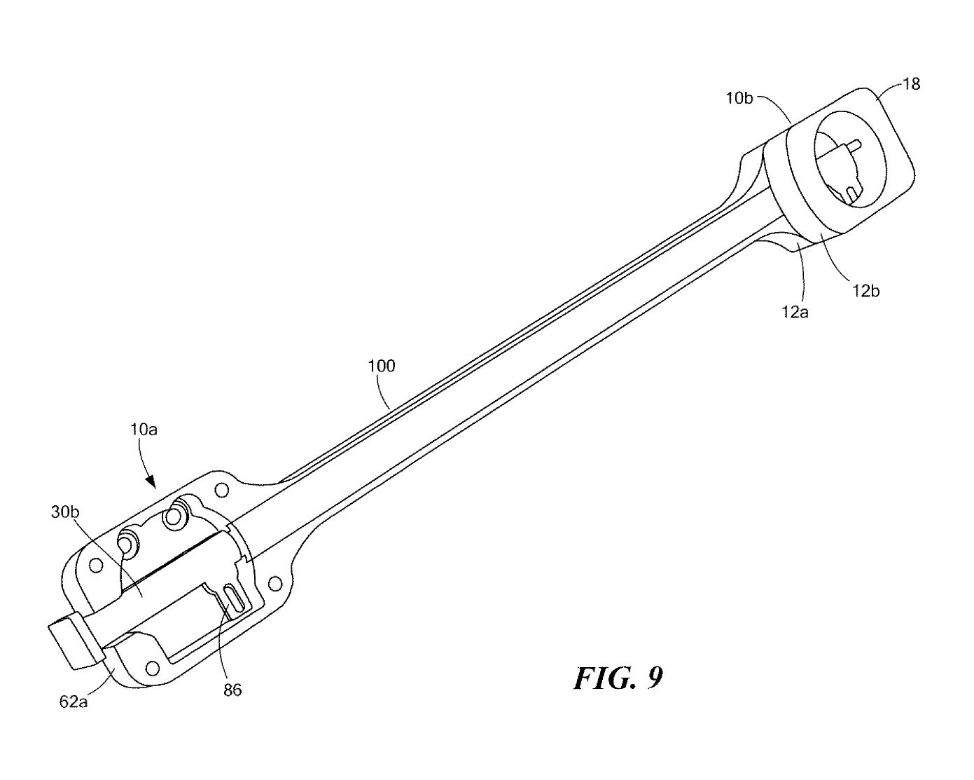

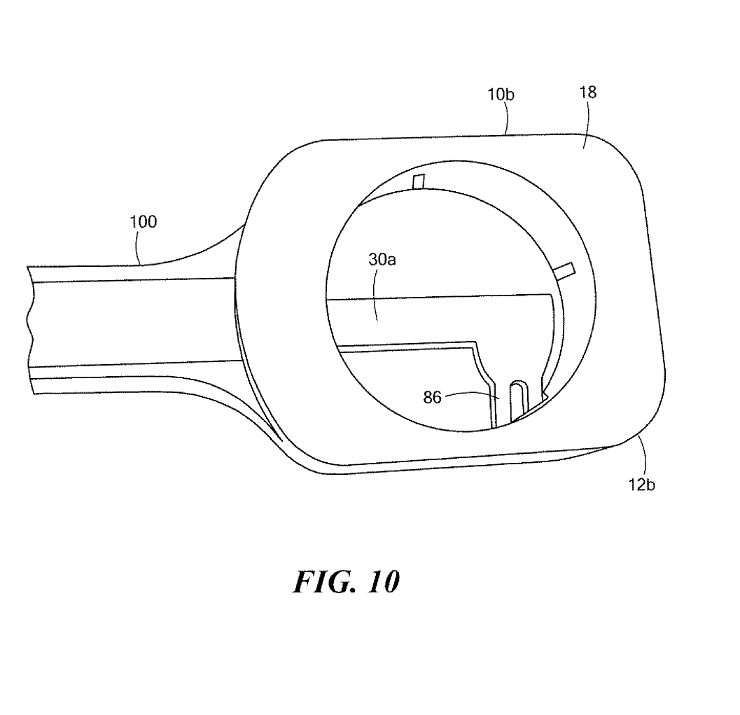

FIGS. 9-10 show two polymer switches 10a and 10b coupled together via member 100 with a channel therein for the lengthy actuator. The bottom housing portion is shown removed for switch 10a. Linear actuator 30b extends through member 100 and thus turns both switches on and off simultaneously.

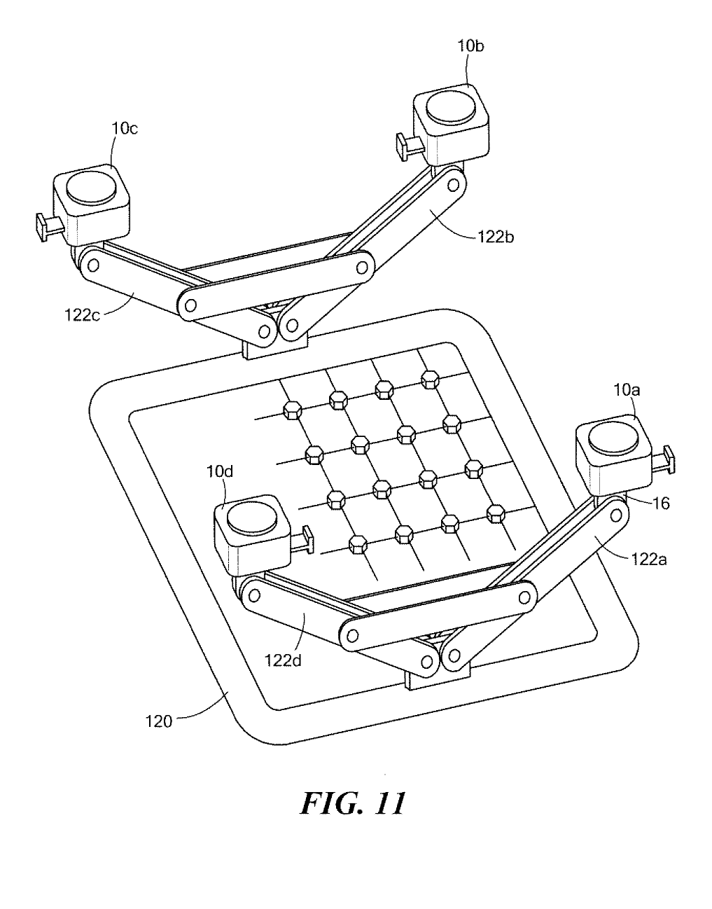

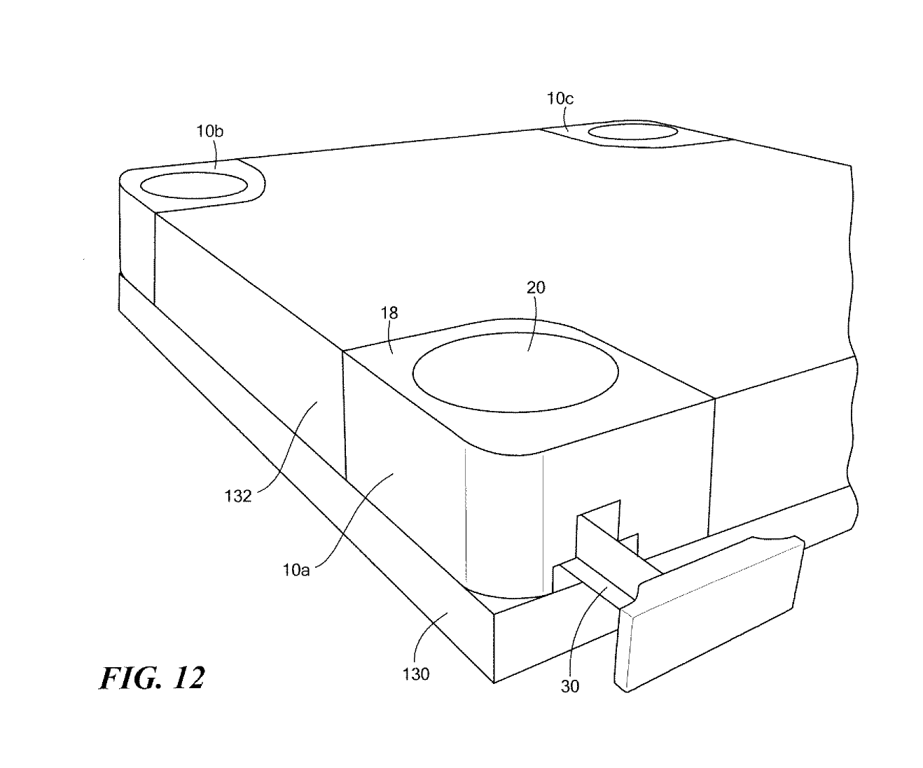

FIG. 11 shows a hard point net assembly 120 with frame struts 122a-122d connected to switches 10a-10d. See U.S. Pat. Nos. 8,042,449 and 8,245,620 incorporated herein by this reference. In this way, hard point net assembly 120 can be removably attached to and removed from a military vehicle in an expeditious manner.

FIG. 12 shows armor panel 130 adhered to the top surface of switches 10a, 10b, 10c, and the like (typically, one switch at each armor panel corner). Foam layer 132 may be included between the bottom surface of panel 130 and the bottom surface of the switches. In this way, the actuators 30 can be used to quickly attach armor panel 130 to a vehicle hull and to quickly remove it therefrom as desired.

In the preferred embodiments shown, the switches have a small footprint, are fairly easy to manufacture, and easy to use. The switches are highly reliable for quick engagement and detachment of one structure to another. Preferably, nothing interferes with the top or bottom of the switch housing which also serves to protect the switch in harsh environments.

Specific features of the invention are shown in some drawings and not in others. This is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A rotary magnet switch comprising:
a housing defining a cavity for a rotary magnet having a first section rotatable with respect to a second section;
a first registration between the housing and the first magnet section;
an actuator extending from the housing; and
a second registration between the actuator and the second magnet section configured to rotate the second magnetic section with respect to the housing and the first magnet section.

2. The switch of claim 1 in which the actuator is slideable with respect to the housing and includes an off axis ear with an orifice therein receiving a pin extending off axis from a bottom surface of the second magnet section.

3. The switch of claim 2 in which the housing includes a linear track for the actuator.

4. The switch of claim 2 in which the actuator includes a slot receiving a pin attached to the housing constraining the actuator to slide linearly.

5. The switch of claim 1 in which the first registration includes pins extending from a side wall of the first magnet section received in a side wall of the cavity.

6. The switch of claim 1 in which the housing includes two sections coupled together.

7. The switch of claim 1 in which the housing cavity has a configuration exposing a top surface of the first magnet section.

8. The switch of claim 6 in which the top surface of the first magnet section is flush with the housing.

9. The switch of claim 7 in which the top surface of the first magnet section extends beyond the housing.

10. The switch of claim 1 in which the housing further includes a fastener component.

11. The switch of claim 10 in which the fastener component is an ear.

12. The switch of claim 1 including two said housings connected via a member.

13. The switch of claim 12 in which the actuator extends into both housings via the member.

14. The switch of claim 1 in which the housing is made of a polymer.

15. The switch of claim 1 in which the actuator extends from a side wall of the housing.

16. A rotary magnet switch comprising:
a housing in two portions defining a cavity for a rotary magnet having a first section residing in and locked to the housing first portion and exposed at one housing surface;
the second housing portion receiving the rotary magnet second section rotatably disposed therein;
an actuator through a side wall of the second housing portion, extending into the cavity, and registered with the rotary magnet second section.

17. The switch of claim 16 in which the actuator is constrained to slide with respect to the second housing portion.

18. The switch of claim 17 in which the housing includes a linear track for the actuator.

19. The switch of claim 17 in which the actuator includes a slot receiving a housing pin constraining the actuator to slide linearly.

20. The switch of claim 17 in which the rotary magnet second section includes a bottom surface pin and the actuator includes a side ear receiving the bottom surface pin.
